(19) United States
(12) Patent Application Publication
(10) Pub. No.: US 2013/0110731 A1
(43) Pub. Date: May 2, 2013

(54) Online Dating System

(71) Applicant: Lead Wey, Las Vegas, NV (US)

(72) Inventor: Lead Wey, Las Vegas, NV (US)

(21) Appl. No.: 13/282,345

(22) Filed: Oct. 26, 2011

(51) Int. Cl. G06Q 99/00

(52) U.S. Cl. 705/319

(57) ABSTRACT

A method and system for balancing the supply of desirable users with the demand by other users to date them in an online dating system is provided. The method includes enabling a first user to make an offer to pay or to be paid a compensation for having a date with a second user. The offer made by the first user is transmitted to the second user. The second user responds to the first user by accepting, rejecting or making a counter offer. The first user and the second user are allowed to communicate only after any one of the users accepts an offer.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE INVENTION

This invention relates to an online dating system and, more particularly to balancing the supply of and demand for dating highly desirable users in an online dating system.

### DISCUSSION OF RELATED ART

Online dating systems allow people to interact and communicate with each other. These dating systems are social networks which provide users of the dating system the opportunity to develop personal relationships with other users. Various online dating websites have been developed in the art that provide an online meeting place for like-minded individuals or couples to register their personal profiles, search and view the profiles of other members, and initiate contact with other members using various communication means like email, winks, text messages, voice messages, video chats, voice chats, and instant messaging.

In any dating system, or social environment, there are always a small number of users that everyone finds desirable. The huge imbalance in the limited supply of such desirable users versus the huge demand by those who want to meet them is the reason why most online dating websites deliver poor end-user experience to their users. More specifically, because there is always a much larger demand for, and a much smaller supply of desirable users, a desirable user is often overwhelmed by the large number of inquiries from prospective suitors and may not have the time to respond to every inquiry he or she receives. On the other hand, an average user who attempts to contact such desirable users will likely be disappointed with the low rate of response, or never receiving a response to his or her inquiries at all. In the end, both desirable and average users end up having a less than perfect end-user experience.

There have been many prior art improvements to online dating systems. One prior art taught in U.S. Pat. No. 7,246,067 issued to Austin on Jul. 17, 2007 describes a method for verifying information submitted by users to an online dating system. Another prior art taught in U.S. Pat. No. 7,203,674 issued to Cohen on Apr. 10, 2007 describes a method and system for integrating real-time speed dating with an electronic dating service. Yet another prior art taught in U.S. Pat. Application No. 20060059130 published to Weiss on Mar. 16, 2006 describes a system and method for improving an online dating service's search results based on a user's compatibility feedback. However, none of the prior art dating systems described above offer a solution to address the imbalance between the limited supply of desirable users and the high demand by users to date and communicate with these popular desirable users.

In light of the foregoing discussion, there is a need for a technique for balancing the supply of and demand for dating highly desirable users in an online dating system. Further, the technique may enhance end user experience of an online dating system.

### SUMMARY OF THE INVENTION

The present invention is a method for online dating in which the opportunity to go out on a date with a user in exchange for compensation may be negotiated and agreed upon by any two users of an online dating system. In one example embodiment of the present invention, users registering for an account on the dating system may specify if the account type is that of a buying user, or a selling user. A selling user is one who is willing to go out on a date with a buying user in exchange for receiving compensation from the buying user, whereas, a buying user is one who is willing to pay compensation to a selling user in exchange for going out on the date with the selling user.

A user initiates an offer to another user of the opposite account type. Upon receiving an offer, the user may reject the offer, accept the offer, or respond with a counter offer. If the user responds with a counter offer, the other user may reject the counter offer; accept the counter offer, or respond again with another counter offer. When a counter offer is submitted, the process goes back and forth until one user either rejects the counter offer or accepts the counter offer. Once an offer has been accepted, communication between the two users is enabled, allowing the users to exchange contact information and schedule a time and place for the date. Each user may provide feedback about the other user after completion of the date.

In another embodiment of the present invention, users registering for an account on the dating system do not need to specify if they are a buying or selling user. Instead, any user of the system may initiate an offer to another user by specifying if the offer is an offer to buy a date, or an offer to sell a date.

By providing a market place where the ability to go out on a date with users of an online dating system may be bought or sold, the present invention introduces an economic model that balances the supply and demand of dating highly desirable users through price. A buying user who really wants to go out on a date with a selling user may make a high offer that the selling user will accept, thereby improving the end user experience for both online dating users. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is an illustration of a webpage of an online dating website, in accordance with one embodiment;

FIG. 2 is an illustration of a profile page, in accordance with an embodiment;

FIG. 3 is a flow chart illustrating a method for balancing supply of and demand for dating desirable users in an online dating system, in accordance with an embodiment;

FIG. 4 is an illustration of a offer management page, in accordance with an embodiment; and

FIG. 5 is a graphical representation illustrating a supply and demand curve showing a state of price equilibrium in an online dating marketplace, in accordance with an embodiment.

### DETAILED DESCRIPTION OF THE PREFERRED EMBODIMENT

The following describes example embodiments in which the present invention may be practiced. This invention, however, may be embodied in many different ways, and the description provided herein should not be construed as limiting in any way. Among other things, the following invention may be embodied as methods or devices. As such, the present invention may take the form of an entirely hardware embodiment, an entirely software embodiment, or an embodiment combining software and hardware aspects. The following detailed descriptions should not be taken in a limiting sense.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The description provided herein is complete and sufficient for those skilled in the arts of systems and web development to implement the methods as described. One embodiment of this dating system may employ a server running an operating system such as Linux, web-server software such as Apache, and database such as MySQL, with methods implemented through a software development language such as PHP or Java. However, the invention should not be limited to the types of software operating system, web-server software, database software, software development language, server or client hardware.

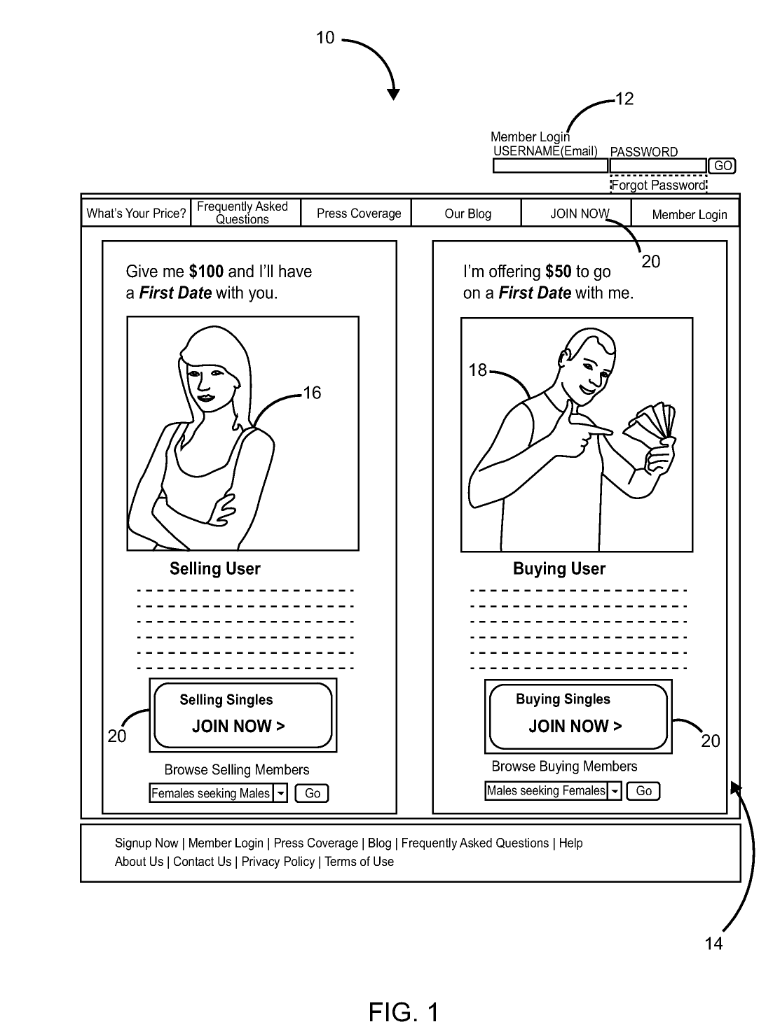

FIG. 1 is an illustration of a webpage 10 of an online dating website, in accordance with one embodiment. The webpage 10 includes a login section 12 and an information section 14. A user enters a username and a password in the login section 12 to login to the online dating website. The username can be an email id of the user or a username selected by the user. The information section 14 of the webpage 10 includes details regarding the user types, account types or the website. A new user may click a “JOIN NOW” button 20 to register into the online dating website. In one embodiment of the present invention, the user can register as a selling user 16 or a buying user 18. A selling user 16 is a user who would go on a first date with the buying user 18 if provided with an offer of compensation. The selling user 16 may also be referred to as “desirable user”. The buying user 18 is a user who wants to go out with the selling user 16 and is willing to offer compensation to the selling user 16 for the opportunity of a first date with the selling user 16. The buying user 18 may also be referred to as “average user”. In one embodiment of the present invention, the selling user 16 may only communicate with the buying user 18 and vice-versa. The selling user 16 and the buying user 18 may be a female seeking male, or a male seeking female, or a female seeking female, or a male seeking male. In another embodiment of the present invention, the selling user 16 and the buying user 18 may also be a couple consisting of two or more male users, two or more female users, or a male and female user.

In another embodiment of the present invention, users register for an account without specifying if the account type is that for a selling user 16 or a buying user 18. Instead, a user of the system may initiate an offer to any other user by specifying if the offer is an offer to buy a first date, or an offer to sell a first date. If the user makes an offer to buy a first date, the user is assuming the role of the buying user 18 in this specific transaction, and hence is making an offer to compensate the other user in exchange for going out on a first date. If the user makes an offer to sell a first date, the user is assuming the role of the selling user 16 in this specific transaction, and hence is making an offer to go out on the first date with the other user in exchange for being compensated by the other user.

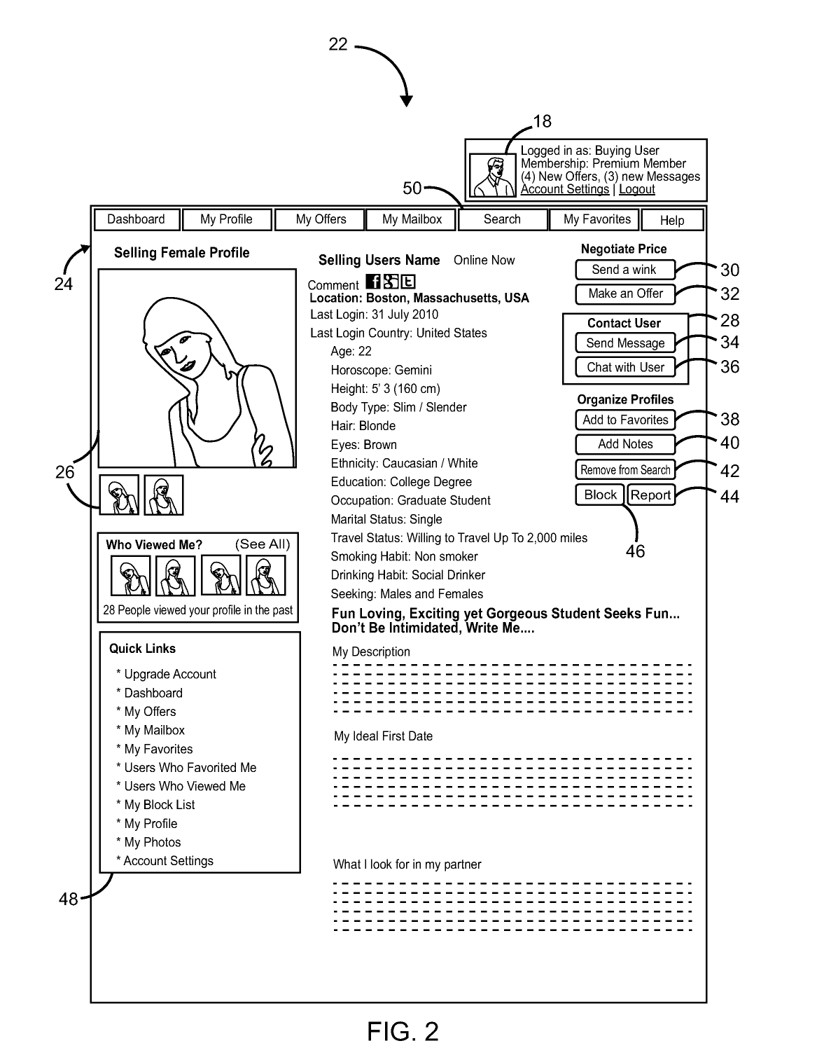

FIG. 2 is an illustration of a profile page 22 of the selling user 16, in accordance with an embodiment. Upon registering into the online dating website, at least one account may be created by the buying user 18 and the selling user 16. The at least one account may be used by the buying user 18 and the selling user 16 to create a profile 24. The profile 24 includes personal information such as age, location, horoscope, marital status, education, occupation, personal description and ideal first date and a plurality of photographs 26. The profile page 22 may include provision for contacting other users, communicating with other users and organizing the created profiles. The selling user 16 and the buying user 18 may contact each other utilizing communication means 28 such as sending an email message 34, instant messaging or chat 36, or other methods of communication including, but not restricted to the following: telephone, mobile text (SMS) messages, voice-over-IP, postal mail, and others. The selling user 16 and the buying user 18 may negotiate an offer to go out on a date by sending an invitation to make an offer 30, or making an offer 32. In an embodiment of the present invention, users are not allowed to communicate with each other directly using any communication means 28 until an offer has been made and accepted between them. The profile 24 may be organized by clicking buttons such as add to favorites 38, and add notes 40. The user can block other users from sending any invitation, new offers or emails utilizing the block button 44. The user can report other users to the administrator of the website for any abuses by using the report 44. The buying user 18 and the selling user 16 may search and view each others' profile 24 using “Search” button 50 available on the profile page 22. The users 16, 18 may utilize “remove from search” button 42 to remove the profile 24 from showing up in any future search results. The profile 24 may include “quick links” 48 to quickly access other areas of the website, such as upgrade account, dashboard, my offers, my mailbox, my favorites, users who favorite me, users who viewed me, my block list, my profile, my photos and account settings.

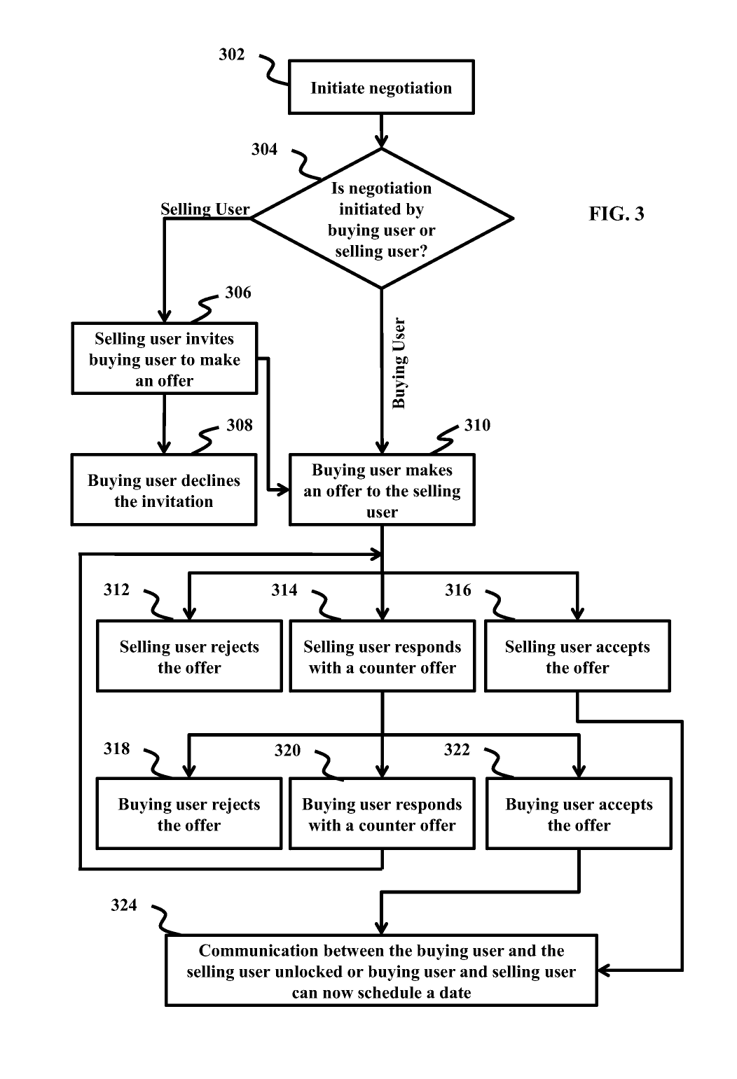

FIG. 3 is a flow chart illustrating a method for balancing supply of and demand for dating desirable users in an online dating system, in accordance with an embodiment. The method adopted in the online dating system facilitates online dating between a selling user 16 and a buying user 18 utilizing the online dating website. After creating an account in the online dating website, a registered user may initiate negotiation with another registered user to schedule a date. At step 302, the negotiation may be initiated. The negotiation can be initiated by a selling user 16 or a buying user 18. At step 306, the selling user 16 may initiate the negotiation by requesting the buying user 18 to make an offer to go on a date with the selling user 16. Thereafter, the buying user 18 may decline the invitation at step 308. Alternatively, at step 310, the buying user 18 can make an offer to the selling user 16. Thereafter, the selling user 16 can either reject the offer at step 312, respond with a counter offer at step 314 or accept the offer at step 316. If the selling user 16 rejects the offer at step 312, then the negotiation may be terminated. Alternatively, if the selling user 16 accepts the offer at step 316, then at step 324 communication between selling user 16 and buying user 18 may be enabled, so selling user 16 and buying user 18 can use any communication means 28 to schedule a date, time and place for dating. Either selling user 16 and buying user 18 may provide a feedback about the other user after their date or after an offer has been made and accepted between them. On the other hand, if at step 314, the selling user 16 makes a counter offer to the buying user 18, then the buying user 18 can reject the offer at step 318, respond with a counter offer at step 320 or accept the offer at step 322. If the buying user 18 rejects the offer at step 318, then the negotiation is terminated. Alternatively, if the buying user 18 accepts the offer at step 322, then at step 324 communication between selling user 16 and buying user 18 may be enabled, so that selling user 16 and buying user 18 can use any communication means 28 to schedule a date, time and place for dating. On the other hand, if the buying user 18 responds with a counter offer, then steps 312 to 324 may be repeated till an offer is accepted or rejected by any one of the selling user 16 and the buying user 18. It shall be noted that a user who receives compensation is referred to as a selling user and a user who offers compensation is referred to as buying user for enabling easy understanding of the embodiments. Such users may also be referred to as first user and second user interchangeably.

In an embodiment, the number of times a selling user 16 or a buying user 18 can make a counter offer can be preconfigured by the online dating system. Additionally or alternatively, the time duration for responding to an offer can be configured by the online dating system or the users.

In an embodiment, a selling user 16 or a buying user 18 may make a fixed price offer, whereby the price names by the user initiating the offer is fixed. Fixed price offers cannot be negotiated, and therefore the user receiving the offer can only accept or reject the offer. In case of a fixed priced offer, no counter offer is permitted.

In an embodiment, at step 306, the selling user 16 can initiate a negotiation by specifying the compensation desired to schedule a date with the buying user 18.

In another embodiment, at step 310, the buying user 18 can initiate a negotiation by requesting a selling user 16 to specify the compensation desired to schedule a date with the buying user.

In another embodiment of the present invention, a user A who is initiating the offer may add additional terms to the offer by including with the offer a description of exactly what is expected, such as, where user A wants to go, what user A wants to do, what user B (who is receiving the offer) is expected to do on their date and any other specific conditions or expectations. In doing so, user A will provide information about the terms of the offer which will allow user B to make a decision whether to accept the offer, reject the offer or counter the offer.

In an embodiment, even the terms of the offer can be negotiated using the online dating system.

In another embodiment, at step 308, 312 or 318, the user rejecting an offer may provide a reason. The reason may be entered by the user, or the user may choose from a list of preconfigured reasons. The reason for rejection is then displayed to the other user.

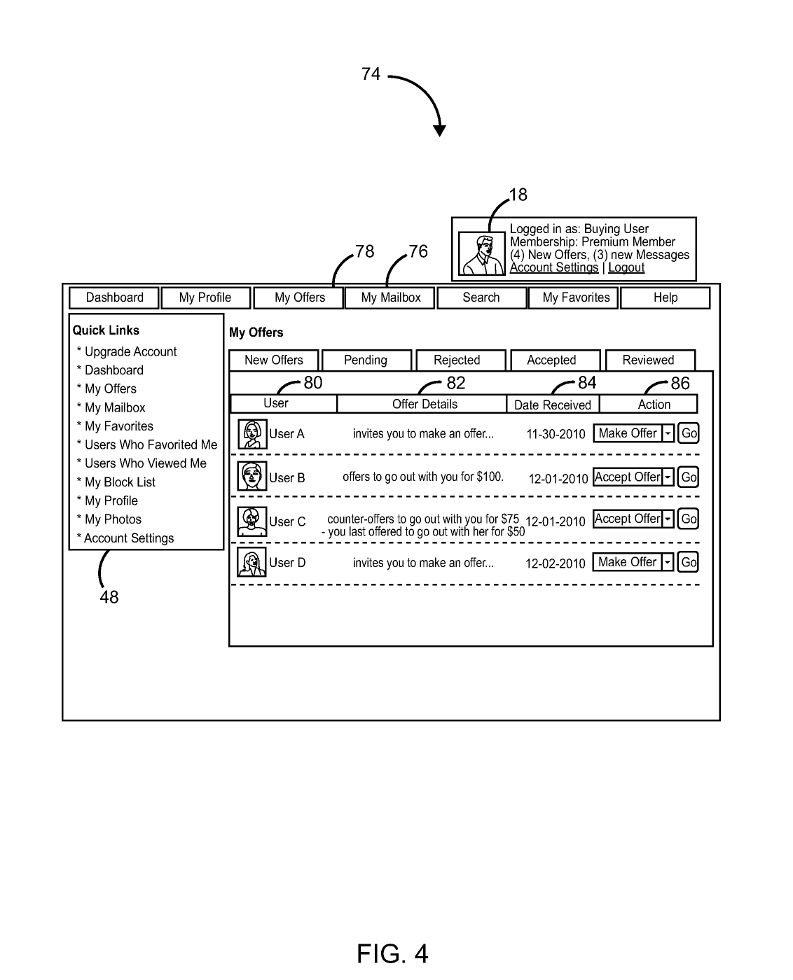

FIG. 4 is an example screenshot of a webpage of the present invention, illustrating an offer management page 74 for a buying user 18. The user may click “My Offers” button 78 on the main menu of the website to navigate to the offer management page 74. The buying user 18 can view the details of any offer made or received in the offer management page 74. The details of each offer may include information such as name or username of the user 80 who sent the offer or to whom the offer was made, offer details 82 such as the amount of the offer or any other terms associated with the offer, date at which the offer is sent or received 84, and the “Action” button 86 to accept, reject or respond with a counter offer. The buying user 16 can check emails received in the email inbox by clicking on the button “My Mailbox” 76 on the main menu of the website. As described in the flow chart of FIG. 3, buying user 18 may choose to respond a selling user 16 with a counter offer. If the selling user 16 responds with the counter offer, the process goes back and forth until the buying user 18 either rejects the offer or accepts the offer. The offer management page 74 may include “quick links” 48 to access other web pages such as the upgrade account page, the member dashboard page, the offer management page, the mailbox page, the favorites page, the users who favorite me page, the users who viewed me page, the block list page, my profile page, my photos page, or the account settings page. The offer management page for a selling user 16 would look and function in a similar manner as the offer management page 74 for the buying user 18.

The processes described above and illustrated in the drawings is shown as a sequence of steps, this was done solely for the sake of illustration. Accordingly, it is contemplated that some steps may be added, some steps may be omitted, the order of the steps may be re-arranged, and/or some steps may be performed simultaneously.

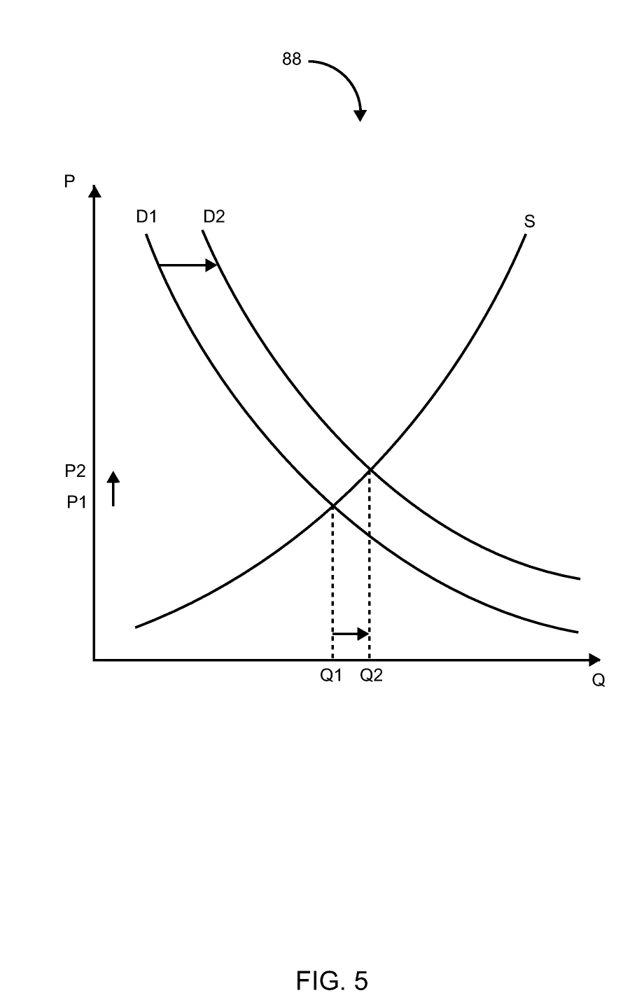

FIG. 5 is a graphical representation, illustrating a supply and demand curve 88 showing a state of price equilibrium in an online dating marketplace of the present invention. The supply and demand of online daters, along with attraction, influence the price a buying user 18 may offer to a selling user 16, and at what price a selling user 16 may accept an offer from a buying user 18. The present invention makes it possible for the buying user 18 to offer a higher price for the selling user 16 that the buying user 18 finds to be more attractive and feels to be in higher demand, while offering a lower price to go out with a different selling user 16 whom the buying user 18 finds to be less attractive and feels to be in lower demand. The present invention allows the selling user 16 to accept a different price from different buying users 18, depending on how attracted the selling user 16 is to each buying user 18. The price P of a product or service is determined by a balance between production at each price (supply S) and the desires of those with purchasing power at each price (demand D) as indicated in the demand and supply curve 88. The positive shift in demand from D1 to D2 is resulting in an increase in price (P) and quantity sold (Q) of the product or service.

In yet another embodiment of the present invention, a buying user 18 may host a date or an event, and specify the time, who will be attending, details of the event and the maximum number of people attending. The event may then be published or advertised in the online dating website to selling users 16 who may indicate an interest to attend the event, or make an offer to attend the event. The event host may choose to accept one or more selling users 16 who respond to the advertisement with an offer to attend. The event host may also invite or make offers to selling users 16 whom they want to be in attendance of the event. Alternatively, a selling user 16 may also host such a date or event, and specify the time details of the event, who will be attending and the maximum number of people attending. In the case where the event host is a selling user 16, the event will be published or advertised in the online dating website to buying users 18. The process of negotiating a price and accepting an offer between the event host and users 16 or 18 would follow the process flow chart as outlined in FIG. 3.

Once an offer has been agreed to, there are many methods by which a buying user 18 may pay a selling user 16. In one embodiment of the present invention, the online dating website does not handle the issue of payment, and instead leaves the details and process of payment between the two users entirely up to the users themselves. In doing so, a buying user 18 may choose to pay a selling user 16 prior to, during, or after the date, and may do so by cash, or any other types of payment method, including but not limited to bank checks, cashier checks or pay-pal. The buying user 18 and the selling user 16 may also choose to barter good or services in exchange for meeting, instead of using cash as payment for the offer. In one embodiment, a selling user 16 may present a wish list or gift registry, allowing the buying user 18 to select a gift from the selling user's 16 wish list or gift registry as the method of payment for the date.

In another embodiment of the present invention, the online dating website may provide a provision to collect the agreed upon price of an offer from the buying user 18 directly, or indirectly through a third party service provider or an escrow service. The collected amount is held in escrow and reimbursed to the selling user 16 after the date has been completed. In this case, the online dating website or its third party escrow service provider may collect a fee for the escrow service provided.

In yet another embodiment of the present invention, the online dating website may collect a payment from either the selling user 16 or the buying user 18 or both prior to the scheduled date. The amount of payment may be fixed or may be a percentage of the offer price agreed to between a selling user 16 and a buying user 18. The timing of such a payment may is occur at any time prior to the scheduled date, either before an offer is made, after an offer is accepted, before or after a selling user 16 and a buying user 18 have scheduled the date. The purpose of this payment will be to ensure a higher chance that both users will show up for the date. After the scheduled date, if both users appeared for the date, then the full amount or partial amount of the payment may be reimbursed to each of the users. If one of the users does not show up for the date as agreed to by both users, then the non-conforming user will not receive any refund or reimbursement.

In yet another embodiment of the present invention, the online dating website may collect a fee from either a selling user 16, or a buying user 18, or both to unlock or enable communication between them after they have agreed to an offer between themselves. The amount of fee collected may be fixed or may be a percentage of the offer price agreed to between the selling user 16 and the buying user 18.

In another embodiment of the present invention, a selling user 16 may specify a date and time, and/or location, he or she is available for the date, and submit the date into an online auction whereby buying users 18 may then bid for the date with the selling user 16. The selling user 16 may restrict the number of buying users 18 from participating in the auction, that is, whether all buying users 18 can participate or only a group of buying users 18 invited by the selling user 16 may participate, or only a group of buying users 18 that meet a set of criteria (such as age, race, location, height, weight, etc.) may participate. The winner of the online auction may be determined based on a number of different algorithms to be specified by the selling user 16 or to be programmed into the business logic of the website. For instance, in one embodiment, the buying user 18 with the highest price wins, in another embodiment the buying user 18 with the second highest price wins, and in yet another embodiment the highest bidder is that is accepted by the selling user 16 wins. Alternatively, the buying user 18 may also specify a date and time, and/or location, he or she is available for a date, and submit the date into a reverse online auction whereby selling users 16 may then bid for the date with the buying user 18.

In another embodiment of the present invention, users may be asked to rate each other on a scale based on a number of specific factors, including timeliness, politeness, whether payment was made, whether the user stayed for the entire date as agreed to. In yet another embodiment of the present invention, users may be asked to provide answers to specific feedback or review questions, or to write and answer any feedback or review questions they may provide. To further prevent abuse, the user who is reviewed may be given the opportunity to respond to any negative feedback by providing an explanation or rebuttal.

While a particular form of the invention has been illustrated and described, it will be apparent that various modifications can be made without departing from the spirit and scope of the invention. Accordingly, it is not intended that the invention be limited, except as by the appended claims.

What is claimed is:

1. A method for balancing supply of and demand for dating desirable users in an online dating system, the method comprising:
receiving from a first user an offer to pay, or to be paid, a compensation to have a date with a second user;
transmitting said offer to said second user;
receiving a response from said second user to either accept, or reject, said offer; and
allowing the two users to communicate only after said offer is accepted.

2. The method according to claim 1 further comprising, receiving a counter offer from one of more of said first user and second user.

3. The method according to claim 2 further comprising, configuring a time duration for responding to said offer.

4. The method according to claim 2 further comprising, configuring number of time said counter offer can be made by one of more of said first user and second user.

5. The method according to claim 1, wherein the communication between said first user and second user is restricted until any one of said first user and second user accept said offer.

6. The method according to claim 1 further comprising, enabling users of the online dating system to block selected users from sending invitations or offers.

7. The method according to claim 1, wherein said compensation is selected from a group consisting of money, points, gifts and credits.

8. The method according to claim 1, wherein payment of compensation is facilitated through an escrow service.

9. The method according to claim 1, further comprising collecting a payment from at least one of the users and refunding at least a part of the payment after successful completion of the date.

10. The method according to claim 1, wherein the communication is enabled after collecting a payment from at least one of the users.

11. The method according to claim 1, wherein the offer is a date for auction.

12. The method according to claim 1, wherein at least one of the users is allowed to provide review or rating corresponding to the other user whom they have dated.

13. The method according to claim 1, wherein the offer is fixed and negotiating the offer is restricted.

14. The method according to claim 1, wherein the offer comprises terms or conditions.

15. The method according to claim 14, wherein the terms or conditions can be negotiated.

16. The method according to claim 1, wherein the offer is to attend an event at a specified location, date and time.

17. The method according to claim 1, wherein user rejecting the offer provides a reason and the reason is displayed to the other user.

18. The method according to claim 2, wherein user rejecting the counter-offer provides a reason and the reason is displayed to the other user.

19. An online dating system for balancing supply of and demand for dating desirable users in the online dating system, the online dating system configured to:
receive from a first user an offer to pay, or to be paid, a compensation to have a date with a second user;
transmit said offer to said second user;
receive a response from said second user to either accept, or reject, said offer; and
allow the two users to communicate only after said offer is accepted.

20. The online dating system according to claim 19 is further configured to set a time duration for responding to said offer.

21. The online dating system according to claim 19 is further configured to receive a counter offer from one of more of said first user and second user.

22. The online dating system according to claim 21 is further configured to set a time duration for responding to said counter offer.

23. The online dating system according to claim 20 is further configured to set number of times said counter offer can be made by one of more of said first user and second user.

24. The online dating system according to claim 19, wherein the communication between said first user and second user is restricted until any one of said first user and second user accept said offer.

25. The online dating system according to claim 19 is further configured to enable users of the online dating system to block selected users from sending invitations or offers.

26. The online dating system according to claim 19, wherein said compensation is selected from a group consisting of money, points, gifts and credits.

27. The online dating system according to claim 19 is further configured to enable users to register in the online dating system as a selling user or a buying user.

28. The online dating system according to claim 19 is further configured to facilitate payment of compensation through an escrow service.

29. The online dating system according to claim 19 is further configured to collect a payment from at least one of the users and refunding at least a part of the payment after successful completion of the date.

30. The online dating system according to claim 19 is further configured to enable communication after collecting a payment from at least one of the users.

31. The online dating system according to claim 19 is further configured to allow at least one of the users to provide review or rating corresponding to the other user whom they have dated.

32. The online dating system according to claim 19 is further configured to provide a fixed offer, wherein negotiation of the offer is restricted.

33. The online dating system according to claim 19 is further configured to specify terms or conditions in an offer.

34. The online dating system according to claim 32, wherein the online dating system is further configured to enable negotiation of the terms or conditions.

35. The online dating system according to claim 19 is further configured so the offer is to attend an event at a specified location, date and time.

36. The online dating system according to claim 19, wherein the online dating system is further configured to allow user rejecting the offer to provide a reason and the reason is displayed to the other user.

37. The online dating system according to claim 19, wherein the online dating system is further configured to allow user rejecting the counter-offer to provide a reason and the reason is displayed to the other user.
